(19) United States
(12) Patent Application Publication
(10) Pub. No.: US 2016/0342590 A1
(43) Pub. Date: Nov. 24, 2016

(54) Computer-Implemented System And Method For Sorting, Filtering, And Displaying Documents

(71) Applicant: FTI Consulting, Inc., Annapolis, MD (US)

(72) Inventor: Chad M. Paulin, Marietta, GA (US)

(21) Appl. No.: 14/718,008

(22) Filed: May 20, 2015

(51) Int. Cl. G06F 17/30; G06Q 10/10; G06Q 50/18

(52) U.S. Cl. CPC G06F 17/30011; G06Q 50/18; G06Q 10/10; G06F 17/30554

(57) ABSTRACT

A computer-implemented system and method for sorting and displaying multiple documents at once is provided. Documents are maintained in a database with a list of the documents associated with one or more variables. A query for document type is received and those documents that satisfy the query are visually sorted and displayed. Filter options for variables of the documents are provided. A filter option is received. The results are filtered based on the selection by identifying the documents of the results in the list with variables that satisfy the selected filter option. A summary or a copy of the document can be linked with each of the filtered results. The filtered documents can be viewed and sorted by filter type to identify inconsistencies between one or more of the filtered documents. The filtered results are transformed into a different deliverable format from the display and transmitted to the user.

### FIELD

This application relates in general to document searches and, in particular, to a computer-implemented system and method for sorting, filtering, and displaying documents.

### BACKGROUND

Reviewing large amounts of data, such as for a legal case or an audit, can be a daunting task that is time-consuming and costly. For instance, in a legal case, preparing and identifying necessary documents and exhibits for use during trial can require large amounts of time from multiple individuals on a legal team. Additionally, finding useful case law and other information necessary to the litigation can be difficult. In one example, determining how the assigned judge has decided on a particular type of case in the past or determining the last case that the judge heard regarding a particular issue can be useful for trial research, but hard to find.

Often times, parties specifically prepare for a single case without utilizing information from other cases. However, reviewing and sometimes using information from previous cases can reduce the time needed for preparing a current case. In one example, a firm is preparing a defense against a defective steering system claim for a vehicle. In a prior case, the firm presented a defense for a defective steering joint. Exhibits and visuals used in the prior case, such as those of a steering wheel system and how the steering wheel works can be obtained and used in the current case. Yet, finding the necessary visuals out of thousands of images generally associated with a trial can be time consuming.

Allowing litigators and other individuals associated with trial preparation to quickly and easily identify documents and exhibits, and obtain useful information to assist with the trial greatly helps reduce preparation time. Currently, with regards to case decisions, trial preparation teams can opt to pay for and receive emails with recent court and administrative decisions; however, recipients of the email are tasked with the job of storing and organizing the case decisions from the emails, which can require large amounts of time. Additionally, merely storing the decisions can make searching and locating a specific case difficult.

Further, performing consistency analyses on large amounts of data can be equally as time consuming and frustrating, since a user must, typically, open one document displayed on a screen at a time, identify a particular section of interest for each displayed document, and then compare the identified sections to determine whether the sections are consistent. To perform the comparison, the user must either tab between multiple windows, one for each document, to determine if the text of each separately displayed document page is inconsistent, or print the different document pages and compare them side by side in a physical environment. Consistency analyses can be performed on regulatory documents and public filings, such as environmental regulations, health and safety reporting, and internal knowledge management. Reducing the time required for and money spent on a data consistency analysis can encourage companies to conduct such an analysis on a more frequent basis to ensure consistency and compliance.

Currently, different types of document display systems exist for viewing multiple documents at a time, such as PivotViewer by Microsoft Corporation, which allows users to visualize and interact with large amounts of information. Specifically, an individual creates a collection of information, which is displayed, and search terms are used to filter the displayed information. However, PivotViewer fails to provide scrollable summaries of documents associated with the filtered results along with a copy of the document itself, as well as multilinks to popup windows for document management and administration.

Therefore, there is a need for an approach to efficiently filter large amounts of documents and visualize only those documents of interest for further analysis or comparison, and also to provide the documents of interest to a user with summary information.

### SUMMARY

An embodiment provides a computer-implemented system and method for sorting and displaying documents. A computer-implemented system and method for sorting and displaying documents is provided. A set of documents is maintained in a database with a list of the documents in the set associated with one or more variables. A query for document type is received from a user and those documents from the set that satisfy the query are identified as results and displayed. Filter options for variables of the documents are provided. A selection of at least one filter option is received. The results are filtered based on the selection by identifying the documents of the results in the list with variables that satisfy the selected filter option. At least one of a summary and/or a copy of the document can be linked with each of the filtered results. The filtered results are transformed into a different deliverable format from the display and transmitted to the user.

Still other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing a computer-implemented system for sorting and displaying documents, in accordance with one embodiment.

FIG. 2 is a flow diagram showing a computer-implemented method for sorting and displaying documents, in accordance with one embodiment.

FIG. 3 is a screenshot showing, by way of example, a Webpage with a set of images.

FIG. 4 is a screenshot showing, by way of example, a Webpage with the images of FIG. 3 sorted in graph view.

FIG. 5 is a screenshot showing, by way of example, a Web page showing, by way of example, images sorted by court case.

FIG. 6 is a screenshot showing, by way of example, a Web page showing, by way of example, the images of FIG. 5 filtered by type.

FIG. 7 is a screenshot showing, by way of example, a Web page showing, by way of example, the images of FIG. 6 sorted by witness.

FIG. 8 is a screenshot showing, by way of example, a Web page with a set of case decisions.

FIG. 9 is a screenshot showing, by way of example, a Web page with a representation of a case decision.

FIG. 10 is a screenshot showing, by way of example, a summary of a selected case decision.

FIG. 11 is a screenshot showing, by way of example, a window for adding a new case.

FIG. 12 is a screenshot showing, by way of example, a window for adding a user subscription.

FIG. 13 is a screenshot showing, by way of example, a window for adding new users.

### DETAILED DESCRIPTION

Parties to a lawsuit or administrative hearing spend large amounts of time preparing their case for presentation to a judge or jury. Case preparation can include background research regarding the assigned judge, case law research to support particular claims or arguments, and preparing exhibits for use during trial. Time and money for preparation can be reduced by utilizing information from prior related cases and allowing users to efficiently search through large amounts of data from the current case and prior cases. Visually sorting and filtering data allows a user to quickly identify desired documents and exhibits from large data sets. Further, the sort and filter visualization tools allow a user to transform displayed results into an output document, which is provided to the user.

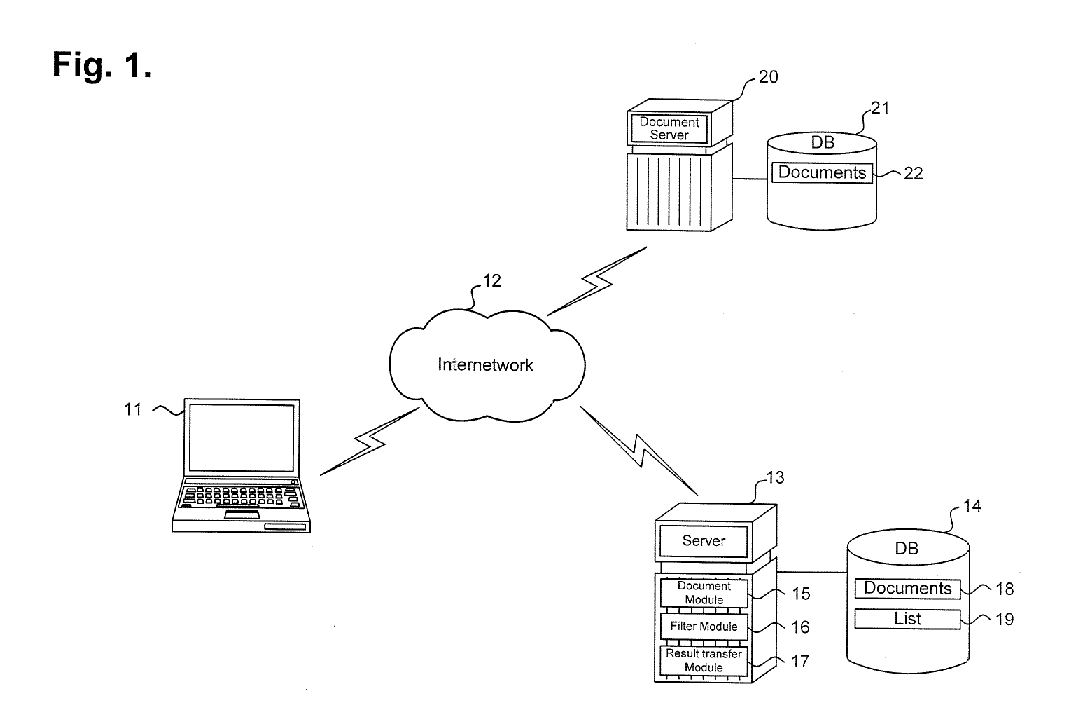

FIG. 1 is a block diagram showing a computer-implemented system for sorting, filtering, and displaying documents, in accordance with one embodiment. An individual associated with a case, such as a judicial trial or administrative hearing, can access a Web-based application for obtaining documents. The documents can include data related to the judicial trials or administrative hearings, such as case decisions, and images or exhibits used during the cases. Additionally, the data can include regulatory documents or public filings. Other types of data are possible. The individual then submits a request for documents via a computing device 11, such as a desktop or laptop computer. The requested is transmitted via an internetwork, such as the Internet 12, to a server 13. The server includes a document module 15, a filter module 16, and a result transformation module 17. The document module 15 accesses a database 14 that is interconnected to the server to obtain the requested documents from a set of documents 18 maintained in the database 14, and transmits the documents to the user. The database 18 can also store a list of documents 19 with associated attributes. Documents 22 for providing to the user can also be obtained from one or more other databases 21 associated with a document server 20.

Representations of the documents are displayed to the user. The representations can include icons or thumbnail images of the documents. In one embodiment, the icons can include two-part icons with a first portion representing a name of the document and a second portion including attributes of the document. The documents are displayed with a set of predefined filter options, which include predefined variables of the displayed documents. Each variable is associated with multiple attributes by which the documents can be sorted or filtered. Specifically, the filter module 16 receives the selected filter and identifies those documents within the display that satisfy the filters and removes the documents that do not satisfy the filter. Alternatively, a user can select one or more of the variables and the filter module sorts the documents by the attributes associated with the variables for display to the user. In one example, the displayed documents are court decisions and the “judge” variable is selected. The cases are then sorted by the individual judges of the cases, such as “Judge Jones,” “Judge Eagan,” and “Judge Malone.”

The same predefined filters or a different set of filters can be displayed with the sorted documents, and the user can select one or more of the filters for further sorting or filtering. The filter selection and sorting can continue until a user finds desired information. Through each filter pass, the number of documents displayed may be reduced based on the filters selected. Once the user has identified the desired documents, the user can interact with the documents by accessing at least one of a copy of the document, a summary of the documents, and other information associated with the document, such as one or more attributes. Additionally, the result transformation module 17 can generate a list of the desired documents or results for providing to the user, as well as provide copies of the desired documents in a different format, such as a presentation document.

The computing device and servers can each include a central processing unit and one or more modules for carrying out the embodiments disclosed herein. The modules can be implemented as a computer program or procedure written as source code in a conventional programming language and is presented for execution by the central processing unit as object or byte code. Alternatively, the modules could also be implemented in hardware, either as integrated circuitry or burned into read-only memory components, and each of the computing devices and server can act as a specialized computer. For instance, when the modules are implemented as hardware, that particular hardware is specialized to perform document filtering and visualization, and other computers cannot be used. Additionally, when the modules are burned into read-only memory components, the computing device or server storing the read-only memory becomes specialized to perform the message prioritization that other computers cannot. Other forms of specialized computers are possible for performing the document filtering and visualization. The various implementations of the source code and object and byte codes can be held on a computer-readable storage medium, such as a floppy disk, hard drive, digital video disk (DVD), random access memory (RAM), read-only memory (ROM) and similar storage mediums. Other types of modules and module functions are possible, as well as other physical hardware components.

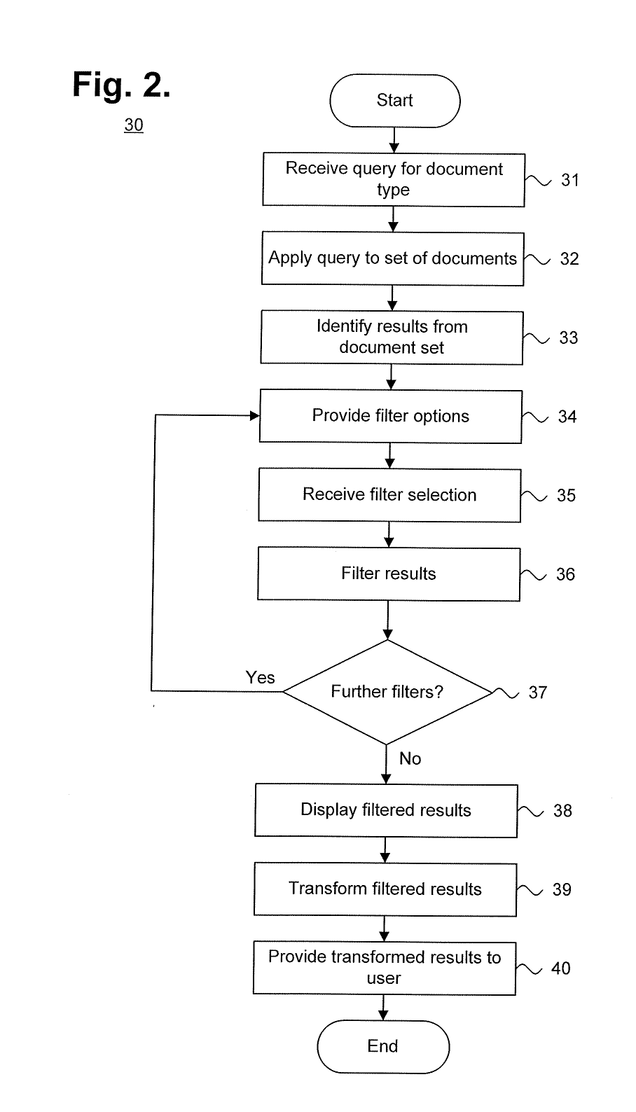

Visually sorting and filtering documents from prior cases provides users with valuable information that can be used to reduce the time needed for preparation of a current case. FIG. 2 is a flow diagram showing a computer-implemented method for sorting, filtering, and displaying documents, in accordance with one embodiment. A user can access a Web page for conducting a document search and provide login information. The login information is reviewed and if verified as correct, the user is then able to enter (block 31) a search query for a particular set of documents. The documents can include images, such as drawings, 3-D images or video, and text, such as case decisions, product labels, and exhibits. Other types of images and text documents are possible. The query is applied (block 32) to a set of documents and document-associated metadata that include documents from previous court cases and administrative hearings, and those documents that satisfy (block 33) the query are selected and displayed to the user as results. Filter and sort options are displayed (block 34) with the results. The filter and sort options can include variables of the displayed documents, which are represented by key terms or topics of the documents. Each variable can be associated with a keyword or topic and is assigned one or more attributes that describe the type of data storable under the variable. For example, a variable for court case could have attributes specifying particular court decisions, such as ABC, Inc. v. TGI, Inc. or Johnson v. Holmes.

The user selects (block 35) one or more of the filter options and the displayed documents are sorted and filtered (block 36), if necessary, using the selected filters. Specifically, the displayed documents that do not include the selected filter option are removed from the display, while the remaining displayed documents are sorted by attributes for the variable associated with the selected filter option. The user can select (block 37) further filter options to further sort and filter the displayed documents. If the user wishes to further filter and sort the documents, further filter options are provided (block 34). However, if no further filtering is to be performed, the filtered results are displayed to the user (block 38). Subsequently, the displayed results can be transformed (block 39) to a different form, such as a PDF document, a list of results, or a presentation document. Finally, the transformed results can be provided to the user (block 40)

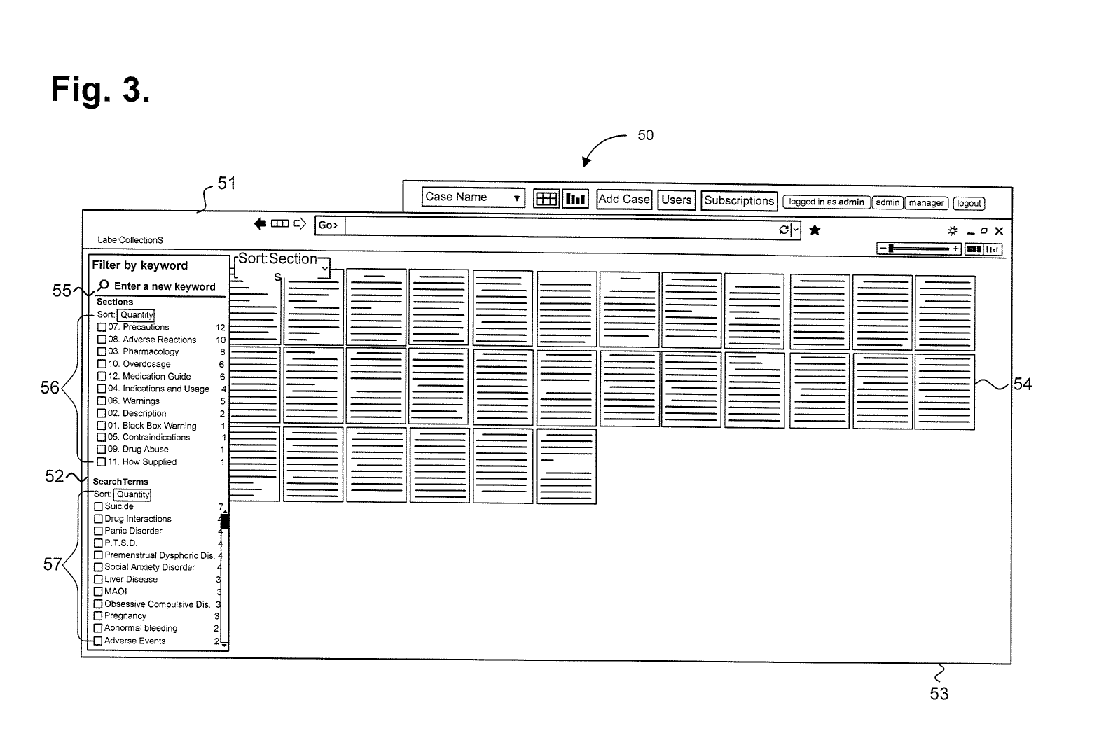

Sorting and filtering documents visually allows a user to easily and timely locate a particular document or determine an answer to a question based on the resulting documents. FIG. 3 is a block diagram showing, by way of example, a Webpage 50 with a set of documents. The Web page 50 can include a header section 51, a filter section 52, and a document display section 53. In one example, a company, Medco, Inc. is being sued for failure to properly warn patients about the side effects, specifically, suicide, of an acne medication named “Facil.” A user associated with Medco wants to identify all documents that include the term “suicide” to provide as exhibits to the jury that show that Medco did warn patients of suicide as a possible side effect of the medication. To identify the relevant documents, the user can enter a query for the Facil drug label, which includes multiple pages of information, which are each displayed as documents 54 in the document display section 53. In one embodiment, a copy of each document can be displayed or icons representing the documents can be displayed. The filter section 52 includes a search bar 55 for a user to enter a query that identifies documents to display and one or more sets of predetermined filters 56, 57, such as for sections of the drug label, and search terms. Each of the different types of filters 56, 57 can include filter options for filtering and sorting the displayed documents. The different types of filters can work in combination with one another or independent of each other to identify and sort the documents.

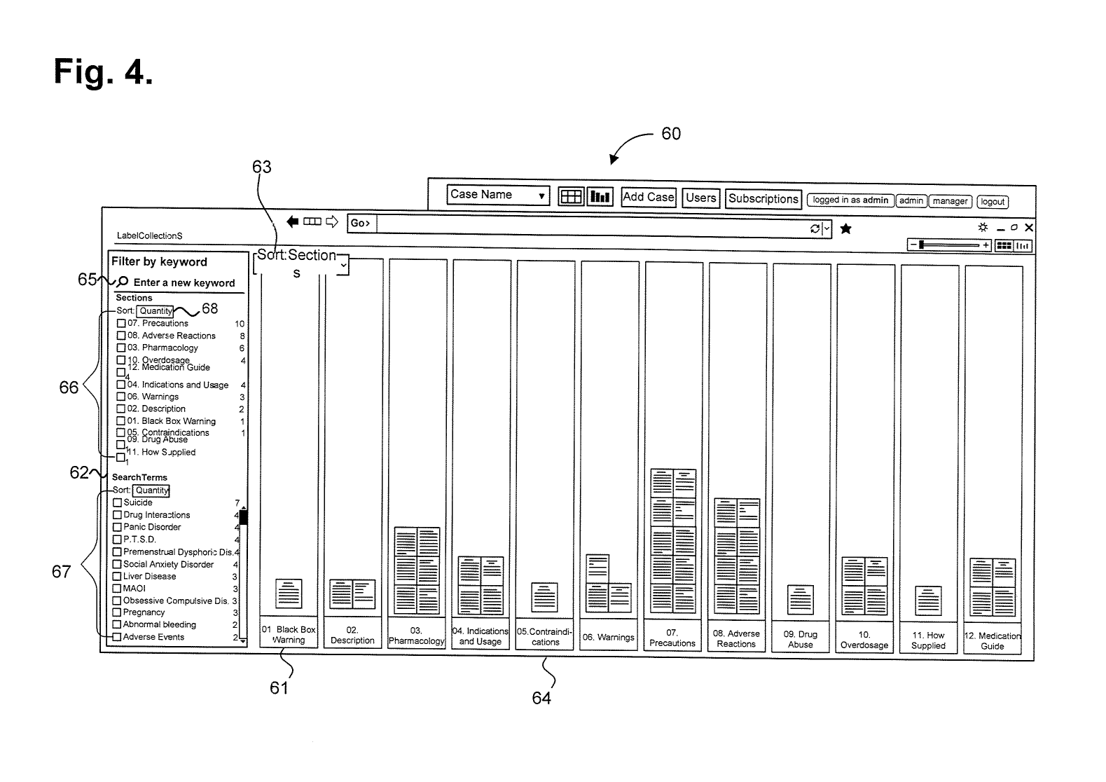

Returning to the above-identified example, the user first selects to sort the displayed documents by label sections. FIG. 4 is a block diagram showing, by way of example, a Webpage 60 with the documents of FIG. 3 sorted by section. The Web page 60 includes a document display section 64, a filter box 62, and a sort box 63. The sort box 63 allows a user to select a specific filter to sort documents displayed within the document display section 64. In this example, the documents represent a drug label. A user selects to sort the documents for the drug label by label section. The Web page 60 also includes a filter section 62 with a search bar 65 and different types of predetermined filters 66, 67. The predetermined filters can include a section filter 66 and a search term filter 67. Since the documents are sorted by section, the section filter 66 lists the titles or headings of each section, which are associated with a selection box and a number of documents within each section. The sections 61 of the drug label include Section 1-Blackblox Warning, Section 2-Description, Section 3-Pharmacology, Section 4-Indications and Usage, Section 5-Contraindications, Section 6-Warnings, Section 7-Precautions, Section 8-Adverse Reactions, Section 9-Drug Abuse, Section 10-Overdosage, Section 11-How Supplied, and Section 12-Medication Guide, and are arranged along a horizontal axis at the bottom of the Web page in the document display section 64.

Each label section 61 is represented by a column, which includes documents for that section. The section filter 66 includes a separate sort box 68 to sort the label sections. In this example, quantity is selected within the sort box 68 and the label sections are listed by a number of documents associated with each label section. The sections can be listed in ascending or descending order based on the document count, or alphabetically. Meanwhile, the search term filter 67 includes a list of key terms located in one or more documents in the document display section 64. Each key term listed is associated with a selection box and an occurrence count that provides a number of documents in which that term is listed. For instance, the term “suicide” is listed in seven documents, while the phrase “drug interactions” is included in only four documents. If the user selects one or more of the label sections or search terms, the documents in the document display section are filtered to only include those documents that are associated with the selected label section or search term.

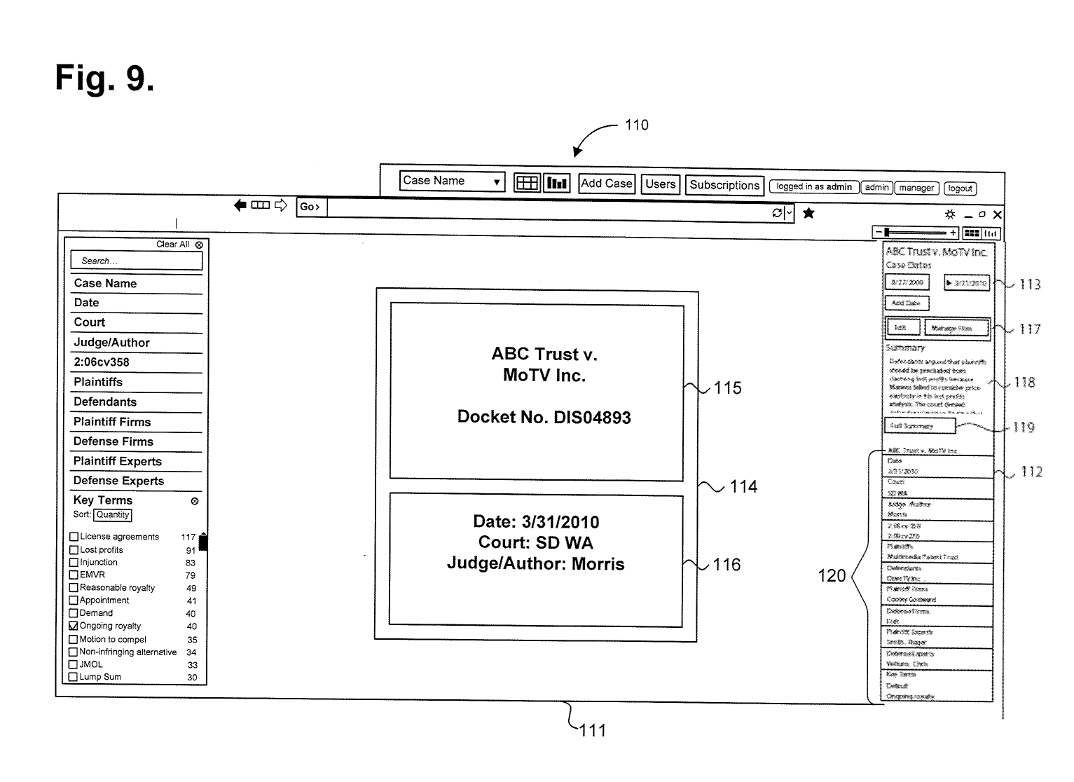

Returning to the above-identified example, the user can filter the sorted documents to identify those documents and sections that mention “suicide” by selecting the search term “suicide” in the search term filter 67. Seven documents that include the term “suicide” are identified and remain in the display sorted by label section, while those documents that do not include the selected key term are removed from the display. Once the seven documents that include suicide are displayed, the user can conduct further actions on each of the displayed documents to obtain further information. For example, the user can select one of the displayed documents to obtain further information about that document. In one embodiment, upon selection of the document, a panel appears on a right side of the Web page and includes metadata for the document, a summary of the document, and hyperlinks to additional pages, as further described below with reference to FIG. 9. In one embodiment, the hyperlinks can open PDF documents related to the selected document, download files related the selected document, or open Web pages associated with the selected document. Further, one or more documents can be transformed to an output document for the user. In one example, the user can select to receive a list of the documents or a copy of one or more of the displayed and desired documents. Alternatively, the displayed documents can be transferred to a presentation document for showing to a jury during trial or can be selected for editing of the actual document.

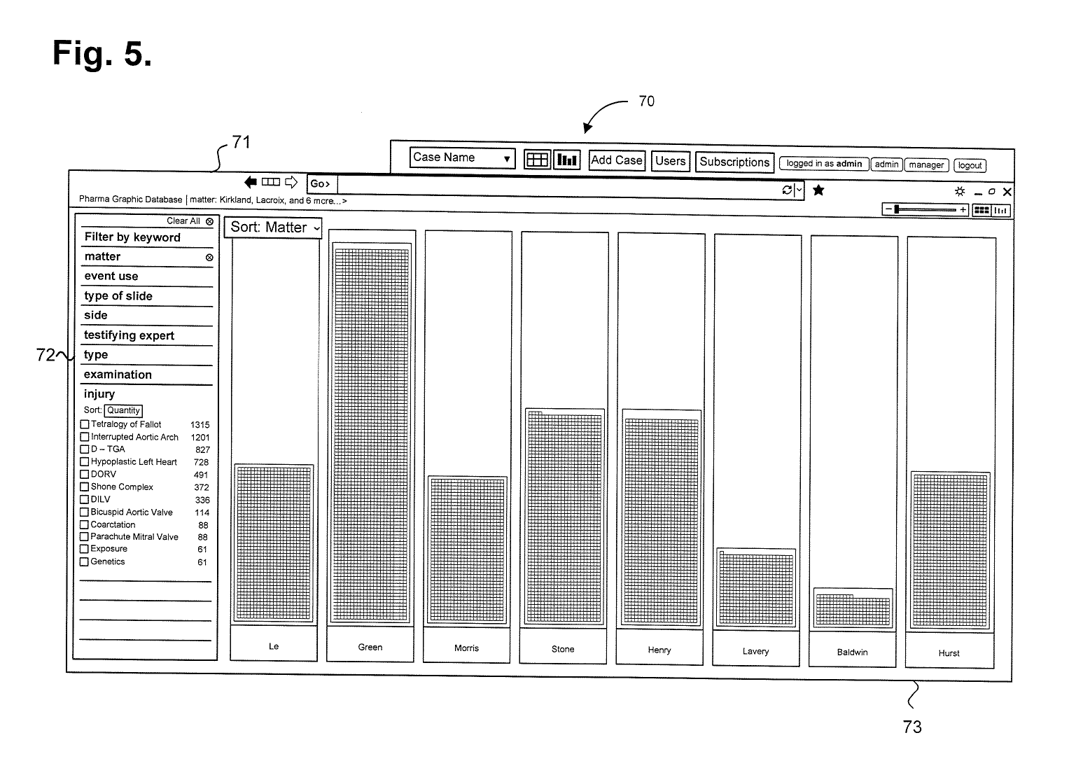

In a further embodiment, the user can use the sort, filter, and visualization tools for identifying images for use during trial. FIG. 5 is a block diagram showing, by way of example, a Web page 70 showing, by way of example, images sorted by court case or matter. The Web page 70 includes a header section 71, a filter section 72, and a document display section 73. A user submits a request for images from previous court cases and administrative hearings in an attempt to identify images of human heart defects that can be used during a current medical malpractice case. Once all the relevant images have been identified, the user elects to sort the images by matter, which includes the cases in which the images were used. Names of the cases are listed along an x-axis in the document display section 73 and the images associated with each case are displayed in a column extending from the case name.

The user can filter the documents to identify particular documents of interest by selecting one of the filter options in the filter section 72 or by selecting a column of documents within the display. In this example, the user selects all images associated with the key term “interrupted aortic arch” in the “Green” case by selecting the phrase “interrupted aortic arch” in the filter section and then selecting the “Green” column. Thus, all images in the Green case that are associated with an interrupted aortic arch remain in the document display section 83, while those images that are not in the Green case and are not related to an interrupted aortic arch are removed from the display.

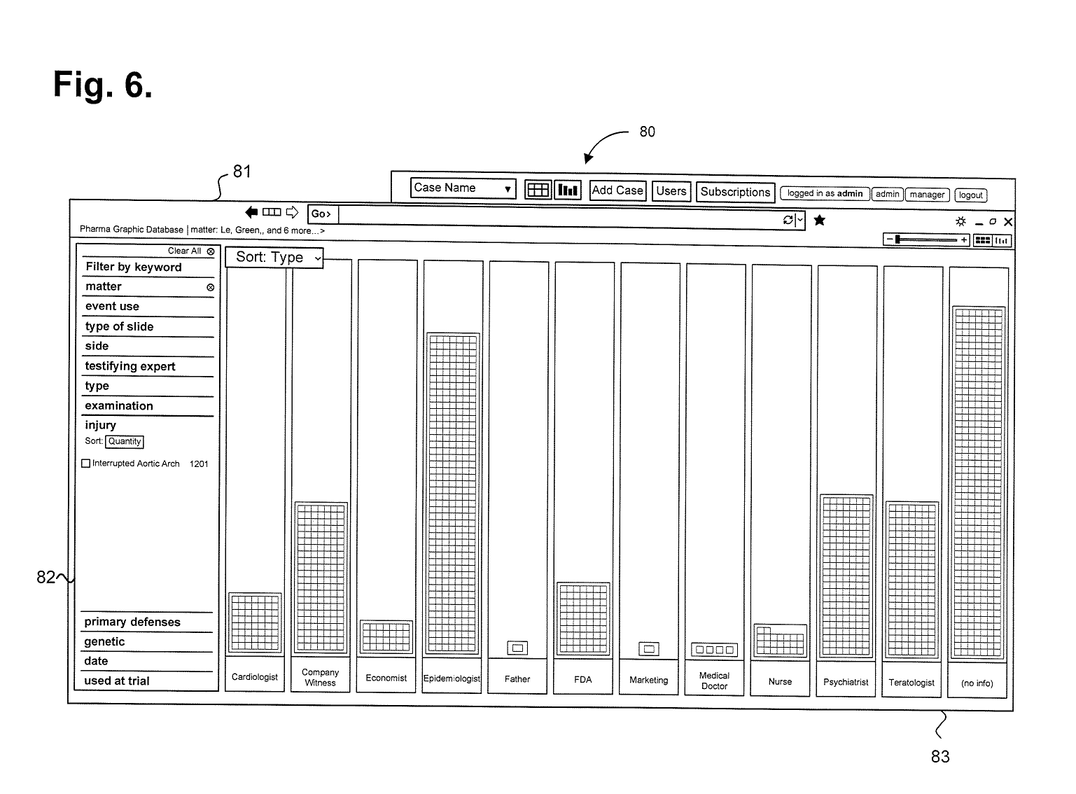

The remaining displayed documents can then be further reviewed for finding one or more images of a heart with an interrupted aortic arch. FIG. 6 is a block diagram showing, by way of example, a Web page 80 with the images of FIG. 5 filtered by type. The Web page 80 includes a header section 81, filter section 82, and document display section 83. In the document display section 83, the user sorts the filtered documents regarding an “interrupted aortic arch” in the Green case by witness type and the filtered images of FIG. 5 are provided in the document display section 83 in columns by type of witness, including cardiologists, company witnesses, economist, epidemiologist, family, FDA, marketing, doctors, nurses, psychiatrist, teratologist, and no information. Other types of witnesses are possible. The images used by each type of witness during the Green case are displayed in columns associated with that witness.

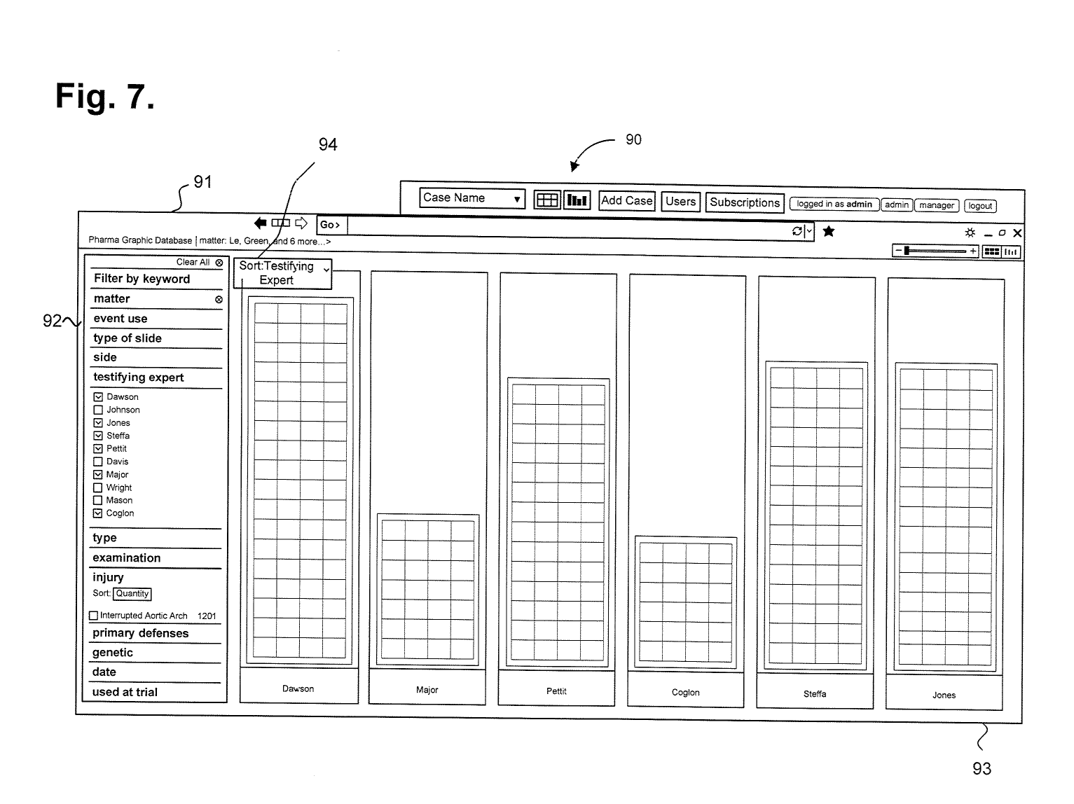

The filters section 82 includes variables associated with each of the images, including matter, event, type, case, testifying expert, title, examination, injury, and defense. Other types of variables are possible. Each variable is associated with multiple attributes relating to one or more of the images. In this example, the user selects to sort the documents by a variable for cardiologist and the images are sorted by the attributes for specific cardiologists that testified during the Green case. FIG. 7 is a block diagram showing, by way of example, a Web page 90 with the images of FIG. 6 sorted by testifying expert 91. The Web page 90 includes a header section 91, a filter section 92, a document display section 93, and a sort box 94. The user selects to sort the documents associated with cardiologists by selecting testifying expert in the sort box 94. All the cardiologist testifying experts are listed in the filter section 92 under a heading for testifying expert. The user then selects six of ten listed experts for displaying documents associated with the selected six experts. Each of the six experts are listed along a horizontal axis near a bottom of the document display section 93. The user can further select one or more filters for identifying a desired document, such as by selecting a particular cardiologist for reviewing the images used by that doctor in an attempt to identify the desired image of a heart.

Once the user identifies the desired heart images, the images can be transformed to an output for providing to the user. For instance, the output can include a list of the displayed images, such as by title or other identifier, or copies of the images. Further, the images can be transformed directly into a presentation document for showing to a judge or jury.

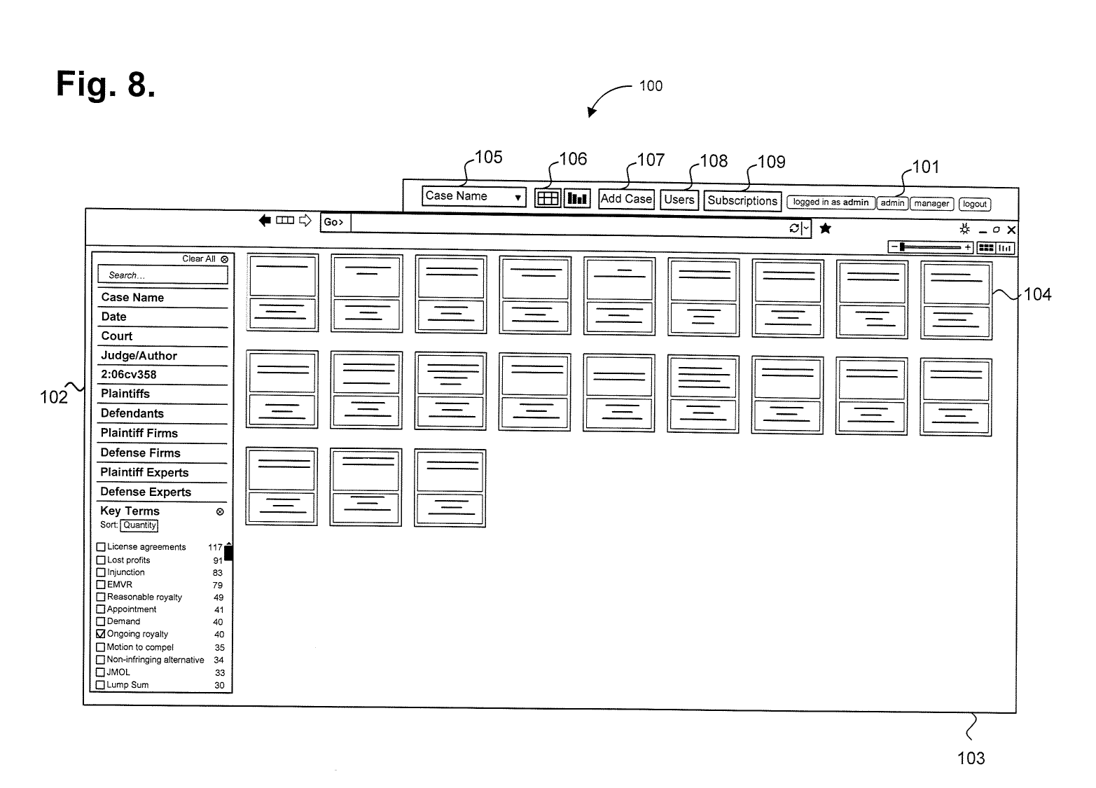

The sort, filter, and visualization tools can also be used to determine information associated with one or more case decisions. FIG. 8 is a block diagram showing, by way of example, a Web page 100 with a set of case decisions. The Web page 100 can include, a filter section and a document display section 103. In the document display section 103, case decisions are displayed. The case decisions can include published judicial or administrative decisions, as well as other types of decisions.

Each case decision in the display can be represented as a two-part icon 104, which includes a first portion and a second portion. FIG. 9 is a block diagram showing, by way of example, a Web page 110 with a representation of a case decision. The Web page 110 includes a document display portion 111 in which case decisions can be displayed. Each case decision can be displayed via a two-part icon 114 having a first portion 115 and a second portion 116. The first portion 115 can include an identifier of the case decision, such as the title or docket no. The second portion 116 can include one or more attributes of the case decision including date of decision, court, judge, parties such as plaintiff and defendant, firms representing the parties, plaintiff experts, defense experts, key terms to describe the case decision and other attributes as elected. In one embodiment, the less icons displayed on the Web page, the larger each icon can be for displaying more information. Other icon representations of the case decisions are possible.

A case management window 112 can, in one example, be located on a right side of the Web page 110, and can include a title of a select document, dates 113 relating to the document, an edit section and file management section 117, a summary section that includes a partial summary 118 and an option to access a full summary 119, and document attributes 120. Other positions of the case management window 112 are possible. In this example, the case management window 112 provides data for the document displayed in the document display section. In a further embodiment, the case management window 112 can be provided when more than one document, or case decision, is displayed within the document display section. When multiple cases are displayed, the case management window can include data for a particular document or case decision over which a selection arrow hovers or which is highlighted.

In the dates section 113 of the case management window 112, a user can identify documents related to the select document by date, such as documents that cite the select document or that are cited by the selected document. The date for the related documents can include a single date or a range of dates. Further, the edit and file management section 117 can include an edit button and a manage files button. The manage files button allows a user to link to a copy of the select document for which the case management window 112 is displayed. A user can choose to download and open a copy of the document. Additionally, a user with sufficient administration privileges can add the linked document and manage the linked document by uploading and linking additional documents, as well as removing documents that are linked. The additional documents can include documents that are related to the linked document. The linked documents can then be opened by a user in another tab. Further, the edit button allows a user with specific administration privileges to edit a copy of the document or data associated with the document that appears in the document management window. Once received from a user, the edits can instantly repopulate within the display.

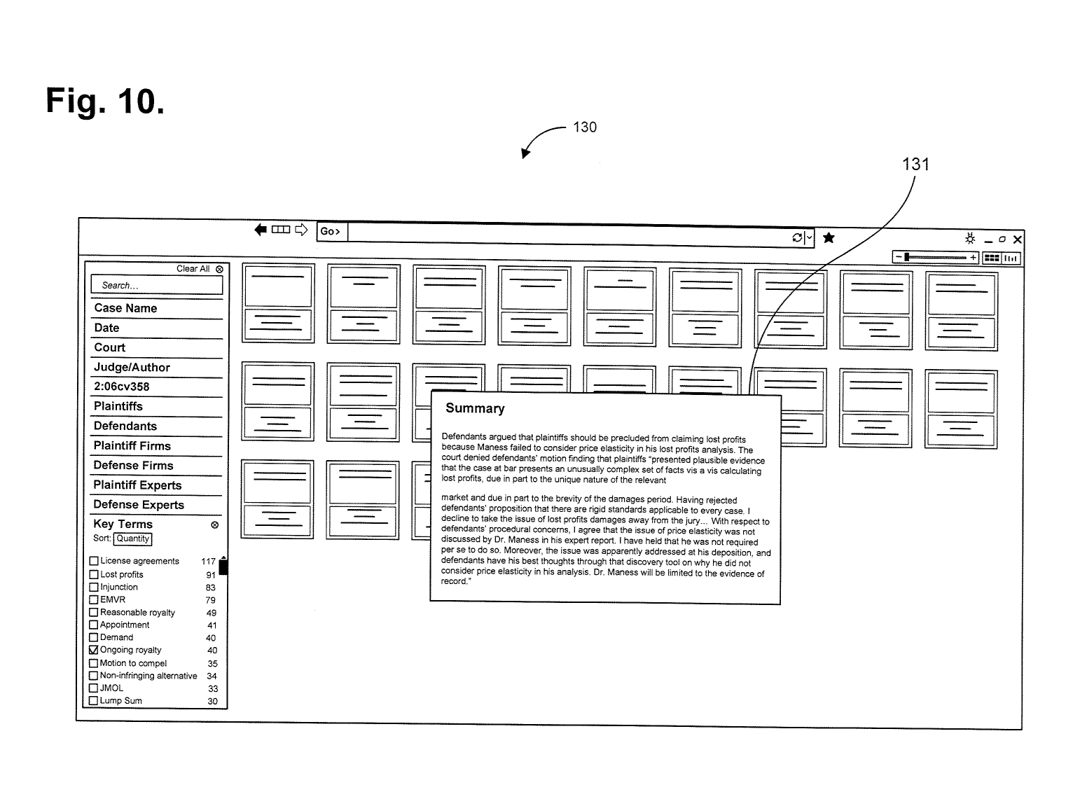

In the summary section 118 of the data management window 112, a user can review the summary information for the selected document. If the summary data is too large to display, a user can click on the full summary button 119. FIG. 10 is a screenshot 130 showing, by way of example, a full summary 131 of a selected case decision. Once a user selects the full summary button in the data management window, a full summary of the select document can be displayed as a separate window over the document display section. When the user no longer needs the summary, the window with the summary can be closed and the full view of the document display section is provided.

The document attributes 120 for a case decision document provide information about the select case to the user and can include one or more of a case name, date, court, judge, plaintiff, defendant, defense firm, plaintiff experts, defense experts, and key terms. For other types of documents, the attributes can include heading or title, summary, content, key terms, date, author, and citations, as well as other types of attributes. Other attributes are possible. Returning to the discussion with respect to FIG. 8, a user wants to identify the last time Judge Eagan decided a case regarding ongoing royalty. To obtain the desired results, the user can select the phrase ongoing royalties from the filter section to access all case decisions regarding ongoing royalties. Subsequently, the case decisions regarding ongoing royalties can be filtered by judge to identify the ongoing royalty cases that were presented in front of each judge. Finally, a specific judge, Judge Eagan, can be selected to identify the ongoing royalty cases he decided and the royalty cases can be sorted by date to identify the most recent ongoing royalty case heard by Judge Eagan. Alternatively, the case decisions can first be sorted by Judge and then filtered by ongoing royalties to identify which case decisions on ongoing royalties were decided by which Judge.

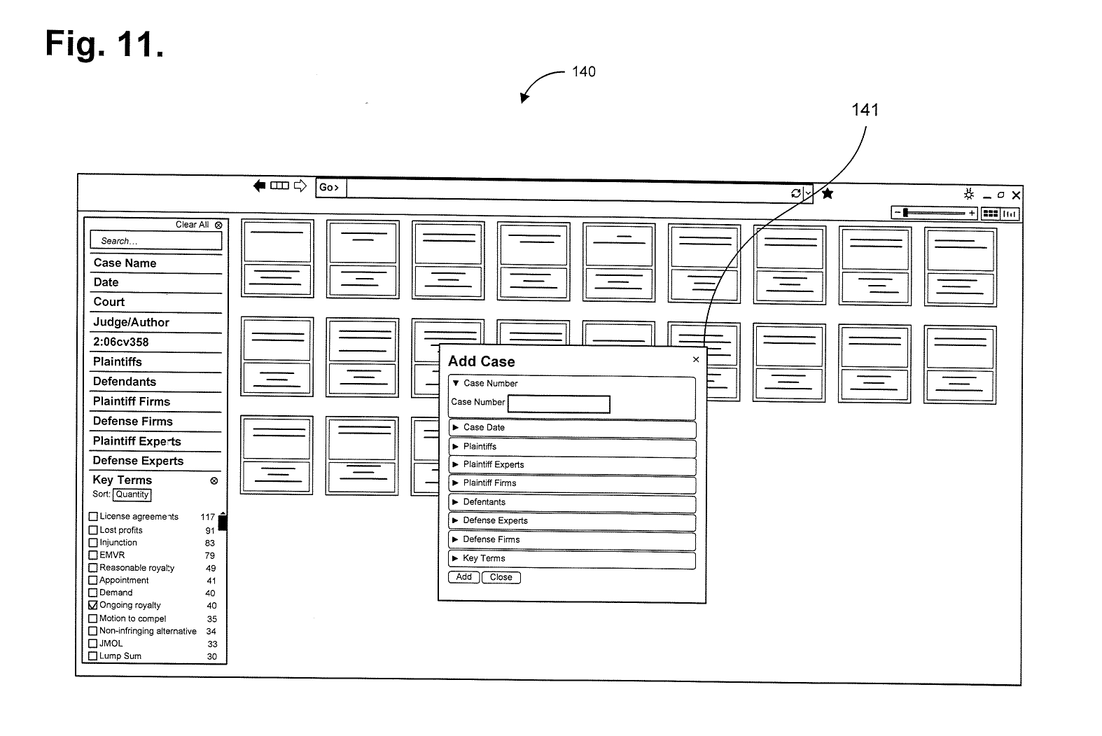

Use of and access to the sort, filter, and visualization tools can be determined by roles of the individuals. The roles can include user roles and administration roles. The user role allows an individual to access, sort, and filter the documents. Meanwhile, the administration role allows use of the sort and filter tools, as well as administrative power to add cases, users, and subscriptions. As shown in FIG. 8, the Webpage 100 includes a user toolbar, which includes a drop down menu 105 for document sorting by title, a document display selector 106, an add case tab 107, a user tab 108, a subscription tab 109, and a user status 101. The document display selector 106 allows a user to select a particular format for displaying the documents, such as individually or in a chart form. The add case tab 107 allows an administrator to add a new case to tool. FIG. 11 is a screenshot 140 showing, by way of example, a window 141 for adding a new case. The window includes attribute fields in which the administrator can enter data about the new case. The attribute fields include case number, case data, plaintiffs, plaintiff experts, plaintiff firms, defendants, defense experts, defense firms, and key terms.

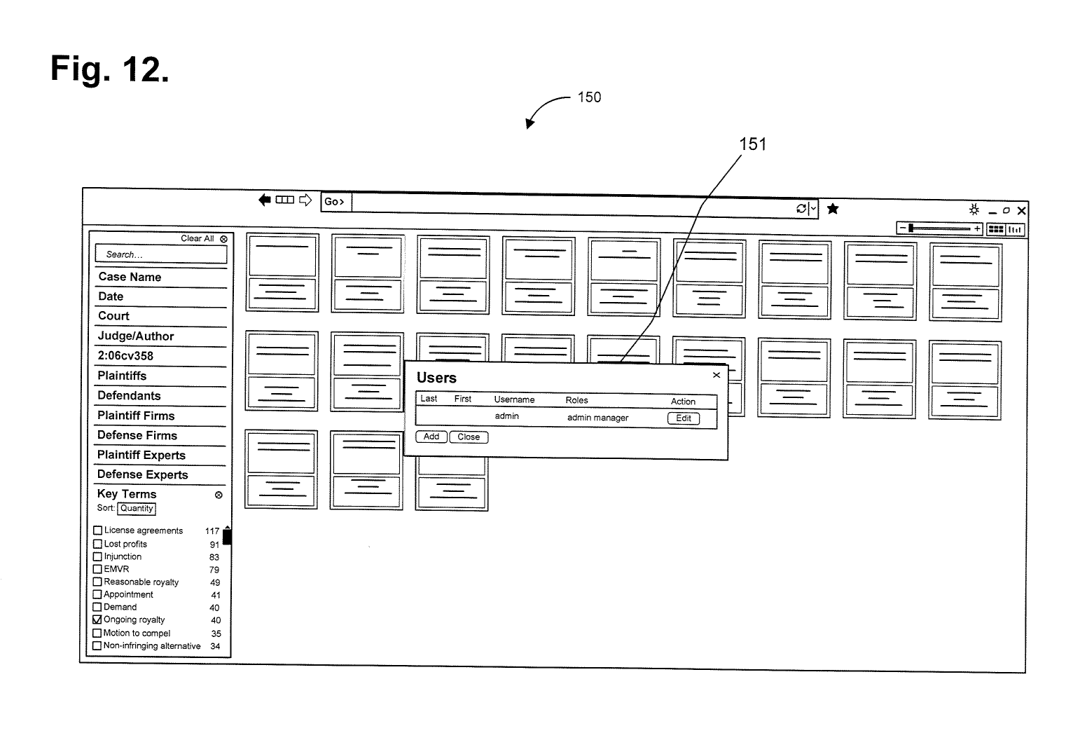

Returning to the discussion with respect to FIG. 8, the user toolbar also includes the user tab 108, which opens a window that allows an administrator the ability to add users, manage users, delete users, and manage passwords. FIG. 12 is a screenshot 150 showing, by way of example, a window 151 for adding new users. The window includes fields for first and last name, username, access role, such as user or administrator, and an action button, which allows the administrator to edit the user information once entered.

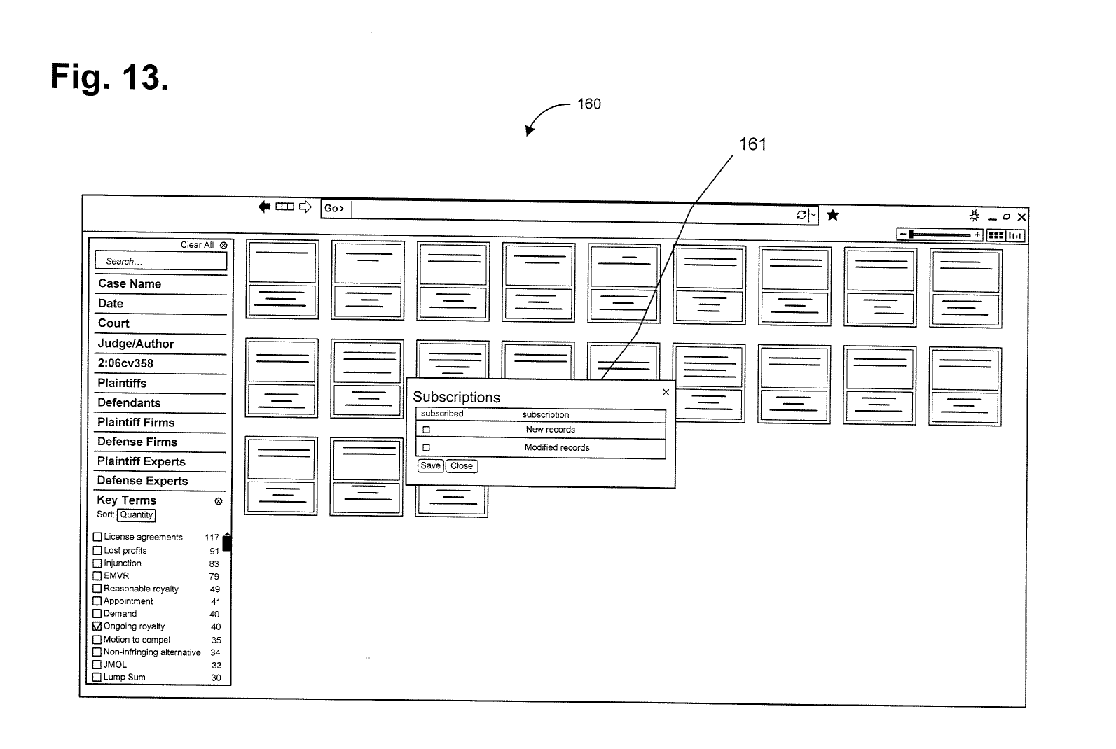

Users and administrators can utilize the subscription tab to open a menu that provides options to receive notifications via email for new items or updated items. FIG. 13 is a screenshot 160 showing, by way of example, a window 161 for adding subscriptions. As new documents are entered into the tool, users can receive copies of the documents. The subscription window 161 allows a user to select how he wishes to receive the documents as well as what type of documents. For instance, the user can receive only new documents or records that have been entered, or documents that have been modified. The documents can be received individually or in a digest.

In a further embodiment, topic models, implementing algorithms such as Latent Dirichlet Allocation and k-means, can be used to identify topics that occur within a collection of unstructured documents, which are displayed within the sort, filter, and visualization tool. For example, if a document set includes a collection of witness trial testimony across different trials, running a topic model across all of the testimony would identify and group document pages from different depositions based on a collection of terms and concepts. Specifically, the documents that are associated with testimony about how much a witness was paid over time are identified via a word cluster of “income, portion, living, money”. In a further example, other documents can be grouped together based on the algorithm generated topic related to causal analysis with a word cluster of “odds, odds-ratio, risk, confidence, interval.”

In a use example for topic models, filters for primary topic, primary strength, secondary topic, and secondary strength can be used. The primary topic filter includes a list of the topics determined by the topic modeling algorithms. The primary strength filter can be represented by a slider bar that allows the user to filter the documents identified by the list of topics, when selected by the user, based on a strength of association between each of the documents associated with the primary topic selected. Other displays for the primary strength filter are possible, such as a text box or drop down menu. For instance, a user selects the group of topics, “income, portion, living, money,” and only those document pages that include one or more topics in the group will be shown on the screen. The slider of the primary strength filter can be adjusted, for instance, between a range of 0.01 and 0.99 to filter the displayed documents; however, other ranges are possible. In one example, when the slider is located between 0.6-0.9, the displayed documents are further filtered to include only the documents with stronger relationships to the primary topics. In contrast, when the slider is adjusted to a range below 0.5, the displayed documents are filtered to include the documents with weaker relationships to the primary topics. Thus, more documents remain in the display when the primary strength filter is set to a lower value.

If an algorithm supports finding more than one topic per document, such as Latent Dirichlet Allocation, then a second topic or word cluster found by the algorithm, after identifying the first topic, is determined. Multiple levels of topics can exist, such as tertiary and quaternary, but the higher levels topics are typically weaker associations. For example, given the sentence, “I just listened to Blues and Jazz on the radio while driving my car”, an LDA model might represent this sentence as 75% (0.75) about music, 25% about cars (0.25) with music being the primary topic and cars being the secondary topic.

The sort, filter, and visualization tools can also be used for other types of documents and to answer other types of questions, such as determining which expert witnesses are most used for providing psychiatric evaluations or for patent valuation analysis.

This tool can also be used to sort, filter and visualize regulatory documents and public filings, those drafted and also filed, to visualize consistencies and inconsistencies between the documents as a consistency visualizer. The consistency visualization can occur by providing multiple pages from multiple documents within a display at the same time for review by a user. During review, the user can identify whether two or more documents, such as for environmental regulations, health and safety reporting, and internal knowledge management where a large organization is seeking to ensure internal consistency in its approach to an issue over time, are inconsistent. Other types of documents for determining a consistency or inconsistency are possible. Specifically, a user can filter a set of documents down to include only those particular topics. Once filtered, the viewer pane only shows the document pages the user has filtered and the user can now sort the displayed pages into side by side columns by filter types, such as name or date.

An example of finding an inconsistency includes loading five years of regulatory filings for use with the tools and selecting a filter that displays, via a viewer pane, only the pages that are related to “telecommunication protocols”. Based on the filtering, thousands of pages from the five years of filings are removed and the displayed pages are reduced to a small number of pages that relate only to the telecommunication protocol the user chose to filter by. Next, the user can sort the pages or documents into columns, such as by document name or date, including creation date or publication date. To view the displayed documents in further detail, the user can zoom in and pan left to right to quickly read and review the relevant pages from multiple documents side by side to visually identify, within a single window, if the paragraphs from two or more documents have inconsistent language. Further, if sorted by date, the user can determine exactly what point in the history of the documents the language became inconsistent. This tool can also be used to sort, filter and visualize transcripts of a particular witness or witnesses in litigation in order to more easily identify inconsistencies in reporting and testimony, both in deposition and in trial.

While the invention has been particularly shown and described as referenced to the embodiments thereof, those skilled in the art will understand that the foregoing and other changes in form and detail may be made therein without departing from the spirit and scope of the invention.

What is claimed is:

1. A computer-implemented system for document identification and delivery, comprising:
a database to maintain a set of documents and a list of the documents in the set with one or more variables;
a query module to receive from a user, a query comprising a document type;
an identification module to identify those documents from the set that satisfy the query as results and displaying the results;
an option module to provide filter options comprising variables of the documents;
a receipt module to receive a selection of at least one filter option;
a filter module to filter the results based on the selection by identifying the documents of the results in the list with variables that satisfy the selected filter option;
a document module to link at least one of a summary and a copy of the document with the filtered results;
a transformation module to transform the filtered results into a different deliverable format from the display; and
a delivery module to transmit the transformed results to the user.

2. A system according to claim 1, further comprising:
an arrangement module to rearrange the displayed results based on the selected filter option.

3. A system according to claim 1, further comprising:
a selection module to select those documents with attributes that satisfy the variable as filtered results.

4. A system according to claim 3, further comprising:
an attribute filter module to receive from the user, a selection of one of the attributes, to filter the documents based on the attribute selection, and to rearrange the display of results filtered by the attribute selection.

5. A system according to claim 1, further comprising:
a document inclusion module to add documents to the database, comprising:
an upload module to upload a document;
a search module to generate searchable text within the document and to identify attributes from the searchable text; and
a list generating module to place identifying information of the document in a list with the identified attributes.

6. A system according to claim 1, further comprising:
a representation module to represent each document in the display with an icon;
an icon selection module to receive a selection of one or more of the icons in the display; and
a page module to open a separate Web page with a copy of the document.

7. A system according to claim 1, further comprising:
a login module to receive login information from the user prior to receipt of the query, to verify the login information for the user, and to accept the query only when the user login information is correctly verified.

8. A system according to claim 1, further comprising:
a topic identification module to identify one or more topics from at least a portion of the document set;
a topic selection module to receive a selection of one or more of the topics; and
a display module to display the documents in the set that are associated with the selected topics.

9. A system according to claim 1, further comprising:
a similarity selection module to receive a selection of similarity strength value; and
a document identification module to identify those documents from the set that satisfy the similarity strength value with the one or more topics.

10. A system according to claim 1, further comprising:
a view module to provide a view of the filtered results for identifying inconsistencies between two or more of the filtered results by displaying the filtered results in columns by date.

11. A computer-implemented method for document identification and delivery, comprising:
maintaining in a database a set of documents and a list of the documents in the set with one or more variables;
receiving from a user, a query comprising a document type;
identifying those documents from the set that satisfy the query as results and displaying the results;
providing filter options comprising variables of the documents;
receiving a selection of at least one filter option;
filtering the results based on the selection by identifying the documents of the results in the list with variables that satisfy the selected filter option;
linking at least one of a summary and a copy of the document with filtered results;
transforming the filtered results into a different deliverable format from the display; and
transmitting the transformed results to the user.

12. A method according to claim 11, further comprising:
rearranging the displayed results based on the selected filter option.

13. A method according to claim 11, further comprising:
selecting those documents with attributes that satisfy the variable as filtered results.

14. A method according to claim 13, further comprising:
receiving from the user, a selection of one of the attributes;
filtering the documents based on the attribute selection; and
rearranging the display of results filtered by the attribute selection.

15. A method according to claim 11, further comprising:
adding documents to the database, comprising:
uploading a document;
generating searchable text within the document;
identifying attributes from the searchable text; and
placing identifying information of the document in a list with the identified attributes.

16. A method according to claim 11, further comprising:
representing each document in the display with an icon;
receiving a selection of one or more of the icons in the display; and
opening a separate Web page with a copy of the document.

17. A method according to claim 11, further comprising:
receiving login information from the user prior to receipt of the query;
verifying the login information for the user; and
accepting the query only when the user login information is correctly verified.

18. A method according to claim 11, further comprising:
identifying one or more topics from at least a portion of the document set;
receiving a selection of one or more of the topics; and
displaying the documents in the set that are associated with the selected topics.

19. A method according to claim 11, further comprising:
receiving a selection of similarity strength value; and
identifying those documents from the set that satisfy the similarity strength value with the one or more topics.

20. A method according to claim 11, further comprising:
providing a view of the filtered results for identifying inconsistencies between two or more of the filtered results by displaying the filtered results in columns by date.
